(19) United States
(12) Patent Application Publication
(10) Pub. No.: US 2007/0183101 A1
(43) Pub. Date: Aug. 9, 2007

(54) Magnetoresistance device including diffusion barrier layer

(75) Inventors: Seong-yong Yoon, Suwon-si (KR); Jae-cheol Lee, Suwon-si (KR); Yong-su Kim, Gangnam-gu (KR); Hoon-sang Oh, Seongnam-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Suwon-si (KR)

(21) Appl. No.: 11/655,936

(22) Filed: Jan. 22, 2007

(30) Foreign Application Priority Data
Feb. 9, 2006 (KR) 10-2006-0012599

(51) Int. Cl. G11B 5/33; G11B 5/127

(52) U.S. Cl. 360/324.2

(57) ABSTRACT

A magnetoresistance device that has a substrate, an underlayer, a magnetoresistance structure, and a diffusion barrier layer is provided. The underlayer is formed on top of the substrate. The magnetoresistance structure is formed on top of the underlayer. The diffusion barrier layer is formed between the underlayer and the magnetoresistance structure.

### CROSS-REFERENCE TO RELATED PATENT APPLICATION

This application claims priority from Korean Patent Application No. 10-2006-0012599, filed on Feb. 9, 2006, in the Korean Intellectual Property Office, the disclosure of which is incorporated herein in its entirety by reference.

### BACKGROUND OF THE INVENTION

1. Field of the Invention

Apparatuses consistent with the present invention relate to a magnetoresistance device, and more particularly, to a magnetoresistance device having a diffusion barrier layer interposed between an underlayer and an anti-ferromagnetic layer in order to prevent diffusion of a material of a magnetic layer caused by a high temperature heat treating process when the magnetoresistance device is formed, which deteriorates the magnetic properties of the device.

2. Description of the Related Art

Numerous process techniques such as thin film deposition techniques, surface processing techniques, etc., have been developed for manufacturing miniature structures. Thus, it is possible to precisely grow a magnetic thin film to a thickness of several nanometers (nm), which is the equivalent of an interaction distance between electron spins, and therefore to manufacture miniature devices. Accordingly, many different characteristics that have not been previously observed in magnetic materials thicker than several nanometers have been discovered and have been subsequently used to manufacture electronic appliances and industrial parts. As a result, magnetoresistance devices have become ubiquitous and are nowadays widely used for magnetic recording heads for writing data on ultra high-density data recording devices, media, and magnetic random access memories (MRAMs).

Examples of magnetoresistance devices that have been widely researched and developed are giant magnetoresistance (GMR) devices and tunneling magnetoresistance (TMR) devices. GMR is a phenomenon wherein a resistance changes depending on the magnetization arrangements of two magnetic layers when electrons pass through the magnetic layers, which can be explained in terms of spin dependent scattering. TMR is a phenomenon where a tunneling current changes depending on a magnetization direction of a ferromagnetic material when an insulator is disposed between two magnetic layers. Also, a TMR head uses the magnetic tunnel junction principle in which a tunneling current varies depending on a magnetization direction of a ferromagnetic material.

FIG. 1 is a cross-sectional view of a related art magnetoresistance device applicable to both a GMR head and a TMR head.

Referring to FIG. 1, the magnetoresistance device includes an underlayer 12, an anti-ferromagnetic layer 13, a first ferromagnetic layer 14, a non-magnetic layer 15, a second ferromagnetic layer 16, and an overlayer 17, which are sequentially stacked on a substrate 11, for example, a Si wafer.

The underlayer 12 may be a single or multi-layer and is typically formed of tantalum (Ta). The anti-ferromagnetic layer 13 is usually formed of an alloy including Mn, such as IrMn, FeMn, NiMn, etc. The first ferromagnetic layer 14 is generally formed of a ferromagnetic material such as a CoFe alloy, and is referred to as a pinned layer since its magnetization direction is pinned by a magnetic field applied by the anti-ferromagnetic layer 13. In a GMR device, a non-magnetic layer 15 may be a spacer layer formed of Cu, and in a TMR device, it may be a tunnel barrier layer formed of Al₂O₃, MgO, etc. The second ferromagnetic layer 16 may be formed of the same ferromagnetic material as that of the first ferromagnetic layer 14, and is referred to as a free layer because its magnetization direction is moveable according to an applied magnetic field. Here, the anti-ferromagnetic layer 13, the first ferromagnetic layer 14, the non-magnetic layer 15, and the second ferromagnetic layer 16 may all be referred to as sensor parts. The overlayer 17 protects the sensor parts formed beneath it, and is usually formed of Ta.

The operation of the magnetoresistance device illustrated in FIG. 1 when used as a magnetoresistance head will be described below. When an external magnetic field is applied to the magnetoresistance device, a magnetization direction of the second ferromagnetic layer 16 with respect to the magnetized direction of the first ferromagnetic layer 14 changes. Thus, the magnetoresistance between the first ferromagnetic layer 14 and the second ferromagnetic layer 16 varies. This variation in magnetoresistance allows sensing of magnetic data stored on a magnetic recording medium, such as a hard disk drive (HDD). In such a manner, data can be read from the magnetic recording medium using the variation in the magnetoresistance between the first and second ferromagnetic layers 14 and 16. Here, when the magnetoresistance device is used, a magnetoresistance (MR) ratio of a change of magnetoresistance to a minimum magnetoresistance and an exchange coupling force (Hₑₓ, i.e., a force required for an anti-ferromagnetic layer to pin the magnetization direction of the first ferromagnetic layer) should be stably maintained.

The magnetoresistance device illustrated in FIG. 1 is subjected to high heat during manufacturing and use. For example, the temperature rises due to the operation of a high-speed spin motor, high temperature heat is applied during deposition of an insulation layer, and a high temperature heat-treating is used during an MRAM manufacturing process for metalization of the circuits. Also, when a magnetoresistance device is used, the magnetoresistance is heated up to 150° C. due to an external current. During a manufacturing process, a magnetoresistance device is heated to a temperature of about 300° C., which is higher than the temperature during use.

If the magnetoresistance device is heated to a high temperature, atoms in each layer begin to move very actively, thus generating interdiffusion or intermixing of atoms between adjacent layers. The interdiffusion or intermixing of atoms is greatly affected by the roughness of a boundary between adjacent layers and the size of crystalline grains. Also, the principal characteristic of a magnetoresistance device, such as the MR ratio or the exchange coupling force, may be degraded due to interdiffusion or intermixing. Especially, in the case where Mn is used to form the anti-ferromagnetic layer 13, Mn is particularly susceptible to diffusion, thereby deteriorating the magnetic characteristics of the magnetoresistance device.

If the above-described related art magnetoresistance devices are heated to a high temperature, their principal characteristic such as the MR ratio or the exchange coupling force are greatly reduced because of very active interdiffusion or intermixing. Also, incorrect sensing of magnetic information frequently occurs during use. Especially, in the case of high-density magnetic recording media, a magnetic field applied from the high-density magnetic recording media is reduced, so that more serious problems occur.

### SUMMARY OF THE INVENTION

The present invention provides a structure for a magnetoresistance device capable of reliably maintaining the magnetic characteristics of the magnetoresistance device, such as a magnetoresistance ratio, throughout its manufacturing process at high temperatures and within the environment in which it is used, and applicable to a wide range of resistance devices.

According to an aspect of the present invention, there is provided a magnetoresistance device having a substrate, an underlayer formed on a top of the substrate, and a magnetoresistance structure formed on a top of the underlayer, the magnetoresistance device including a diffusion barrier layer formed between the underlayer and the magnetoresistance structure.

The diffusion barrier layer may be formed of Ru.

The magnetoresistance structure may include an anti-ferromagnetic layer, a first ferromagnetic layer formed on a top of the anti-ferromagnetic layer, and having a magnetization direction pinned by the anti-ferromagnetic layer; a non-magnetic spacer layer formed on a top of the first ferromagnetic layer; and a second ferromagnetic layer formed on a top of the spacer layer, and having a changeable magnetization direction.

The anti-ferromagnetic layer may be formed of an alloy containing Mn.

The magnetoresistance structure may include an anti-ferromagnetic layer; a first ferromagnetic layer formed on a top of the anti-ferromagnetic layer, and having a magnetization direction pinned by the anti-ferromagnetic layer; a tunneling barrier layer formed on a top of the first ferromagnetic layer; and a second ferromagnetic layer formed on a top of the tunneling barrier layer, and having a changeable magnetization direction through an application of a magnetic field.

The anti-ferromagnetic layer may be formed of an alloy containing Mn.

The underlayer may be one of a single layer, that is, a seed layer, and a multi-layer that includes a seed layer and a buffer layer.

The seed layer may be formed of one of Ta and an alloy containing Ta.

The buffer layer may be formed of one of a Ta/Ru compound and NiFeCr.

### BRIEF DESCRIPTION OF THE DRAWINGS

The above and other aspects of the present invention will become more apparent by describing in detail exemplary embodiments thereof with reference to the attached drawings, in which:

FIG. 1 is a schematic sectional view of a related art magnetoresistance device;

FIG. 2 is a schematic sectional view of a magnetoresistance device according to an exemplary embodiment of the present invention;

FIG. 3A is a sectional view of a magnetoresistance device applied to a GMR configuration according to an exemplary embodiment of the present invention;

FIG. 3B is a sectional view of a magnetoresistance device applied to a TMR configuration according to an exemplary embodiment of the present invention;

FIG. 4A is a graph illustrating an M-H characteristic when a magnetoresistance device without a diffusion barrier layer is in an as-depo state;

FIG. 4B is a graph illustrating an M-H characteristic when a magnetoresistance device without a diffusion barrier layer is formed and then heated at a temperature of 600° C. for 32.5 seconds;

FIG. 5A is a graph illustrating an M-H characteristic when a magnetoresistance device according to an exemplary embodiment of the present invention is in an as-depo stage;

FIG. 5B is a graph illustrating an M-H characteristic when a magnetoresistance device according to an exemplary embodiment of the present invention is heated at a temperature of 600° C. for 32.5 seconds;

FIG. 6A is a graph illustrating results of component distribution as measured by a Secondary Ion Mass Spectroscopy (SIMS) after a related art perpendicular magnetic recording medium without a diffusion barrier layer is formed and then heat-treated at a temperature of 600° C.; and

FIG. 6B is a graph illustrating results of component distribution as measured by an SIMS after a perpendicular magnetic recording medium including a diffusion barrier layer according to an exemplary embodiment of the present invention is formed and then heat-treated at a temperature of 600° C.

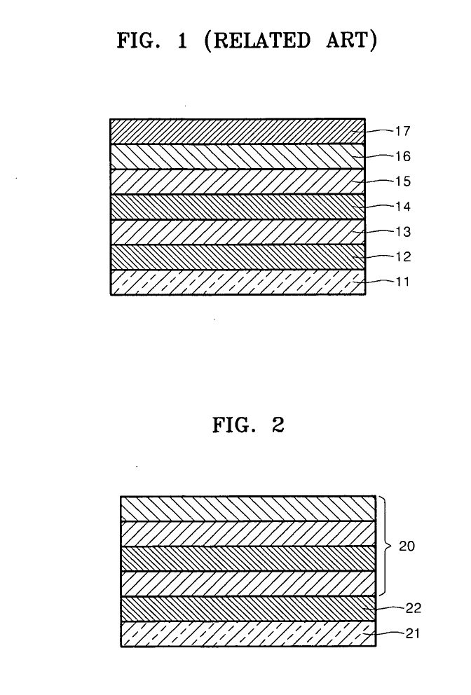

### DETAILED DESCRIPTION OF EXEMPLARY EMBODIMENTS

The present invention will now be described more fully with reference to the accompanying drawings, in which exemplary embodiments of the invention are shown. In the drawings, the thicknesses of layers and regions are exaggerated for clarity.

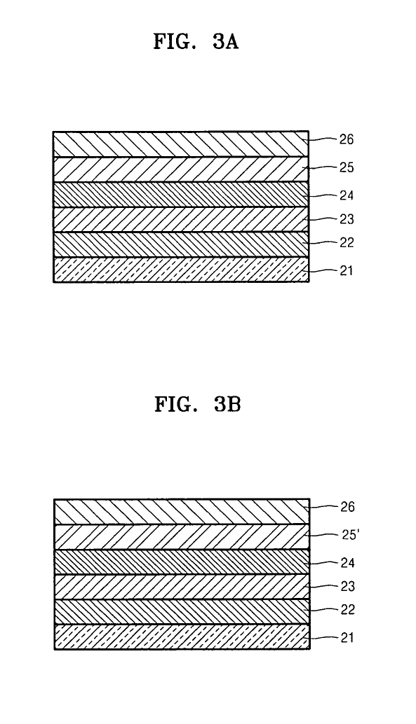

FIG. 2 is a schematic sectional view of a magnetoresistance device according to an exemplary embodiment of the present invention.

Referring to FIG. 2, the magnetoresistance device includes a diffusion control layer and a magnetoresistance device substrate (not shown) on which an underlayer 21, a diffusion barrier layer 22, and a magnetoresistance structure 20 are formed. The magnetoresistance structure 20 may be a sensor when the magnetoresistance device is a magnetoresistance head, and may be a memory unit when the magnetoresistance device is an MRAM or a memory device.

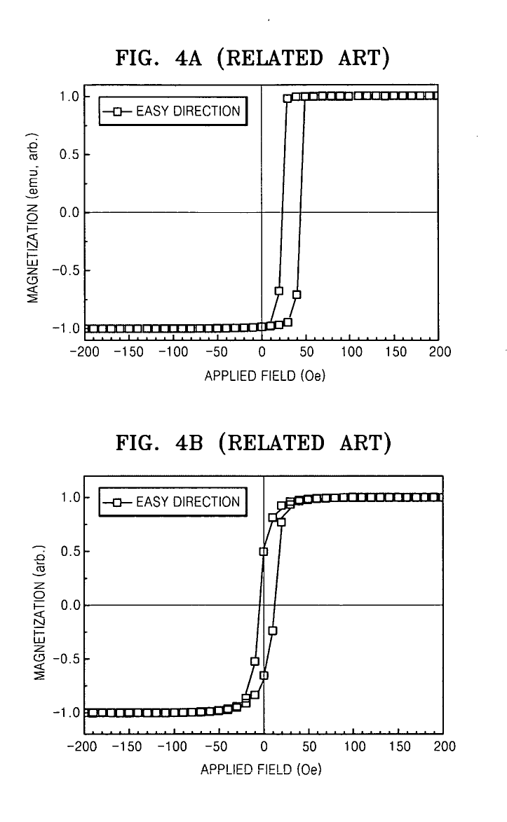

As illustrated in FIG. 2, the magnetoresistance device may be a GMR structure or a TMR structure. FIG. 3A is a sectional view of a magnetoresistance device applied to a GMR configuration according to an exemplary embodiment of the present invention, and FIG. 3B is a sectional view of a magnetoresistance device applied to a TMR configuration according to an exemplary embodiment of the present invention. FIGS. 3A and 3B illustrate spin valve type magnetoresistance devices.

Referring to FIG. 3A, a substrate (not shown) includes an underlayer 21, a diffusion barrier layer 22, an anti-ferromagnetic layer 23, a first ferromagnetic layer 24, a spacer layer 25, and a second ferromagnetic layer 26 sequentially formed thereon. Here, the underlayer 22 may selectively be formed as a multi-layer including a seed layer and a buffer layer. Also, the second ferromagnetic layer 26 may further include an overlayer.

The substrate is used in a general magnetoresistance device, and may be used without restrictions. For example, an Si substrate may be used, and may be oxidized on top of the Si substrate to form SiO₂. The underlayer 21 may be a single seed layer or a multi-layer including a seed layer and a buffer layer. The seed and buffer layers are for growing a magnetic layer thereabove. The seed layer may be formed of Ta or a Ta alloy, and the buffer layer may be formed of a Ta/Ru compound or NiFeCr, etc.

The diffusion barrier layer 22 prevents the diffusion of transition metals (Mn, Fe, Co, Ni, etc.) of the buffer layer of the underlayer 22 or the antiferromagnetic layer 23, and may be formed of a non-magnetic material so that it does not affect the growing of the antiferromagnetic layer 23 formed on top thereof. Specifically, materials such as Ru may be used to form the diffusion barrier layer 22 to a thickness from several to several tens of nanometers. When the materials forming a magnetic layer diffuse beyond the boundaries, a magnetic hysteresis loop changes, so that the resolution of the magnetoresistance device such as a perpendicular magnetic recording medium is degraded. Thus, by using the diffusion barrier layer 22, the magnetoresistance device can retain its recording characteristics when it is subjected to a heat treating process. A detailed description of this phenomenon will be given below.

The antiferromagnetic layer 23 fixes the magnetization direction of the first ferromagnetic layer 24 formed thereon. As such, the antiferromagnetic layer 23 may be formed of an Mn-type compound like IrMn. The first and second ferromagnetic layers 24 and 26 may be formed of CoFe, NiFe, or other ferromagnetic materials. The spacer layer 25 may be formed of Cu or other non-magnetic materials.

FIG. 3B illustrates a structure having an underlayer 21, a diffusion barrier layer 22, an anti-ferromagnetic layer 23, a first ferromagnetic layer 24, a tunneling barrier layer 25′, and a second ferromagnetic layer 26 sequentially stacked on a substrate (not shown). The underlayer 22 may selectively be a multi-layer including a seed layer and a buffer layer, and an overlayer may be further included atop the second ferromagnetic layer 26.

The substrate is one that is used in a general magnetoresistance device, and may be used without restrictions. A Si substrate may be used, and the top of the Si substrate may be oxidized to form SiO₂. The underlayer 21 may be a single seed layer or a multi-layer including a seed layer and a buffer layer. For example, the seed layer may be formed of Ta or a Ta alloy, and the buffer layer may be formed of a Ta/Ru compound or NiFeCr, etc. The diffusion barrier layer 23 prevents the diffusion of transition metals (Mn, Fe, Co, Ni, etc.) forming the buffer layer of the underlayer 21 or the anti-ferromagnetic layer 23, and may be formed of a non-magnetic material so that it does not adversely affect the growing of the anti-ferromagnetic layer 23 formed on top thereof. Specifically, materials such as Ru may be used to form the diffusion barrier layer 23 to a thickness from several to several tens of nanometers. The anti-ferromagnetic layer 23 fixes the magnetization direction of the first ferromagnetic layer 24 formed thereon. As such, the anti-ferromagnetic layer 23 may be formed of an Mn-type compound like IrMn. The first and second ferromagnetic layers 24 and 26 may be formed of CoFe, NiFe or other ferromagnetic materials. The tunneling barrier layer 25′ may be formed of a non-magnetic material such as Al2O3 or MgO.

A process of manufacturing a magnetoresistance device including a diffusion barrier layer according to an exemplary embodiment of the present invention is explained briefly below. Here, the magnetoresistance device with a GMR structure shown in FIG. 3A is formed through a sputtering process, which is explained below.

A substrate of Si is prepared, and an oxidized layer having a predetermined thickness may selectively be formed on the surface of the substrate. Then, in order to form the underlayer 21 on the substrate, a Ta seed layer is formed, and a buffer layer may be selectively formed thereabove. When an alloy material is to be deposited, an alloy target may be deposited, or a separate target may be mounted inside a reactant chamber and the alloy material is deposited through co-sputtering. Then, Ru is deposited to a thickness of several to several tens of nanometers on top the underlayer 21, thereby forming the diffusion barrier layer 22. Then, an anti-ferromagnetic layer 23, a first ferromagnetic layer 24, a spacer layer 25, and a second ferromagnetic layer 26 are sequentially formed on the diffusion barrier layer 22.

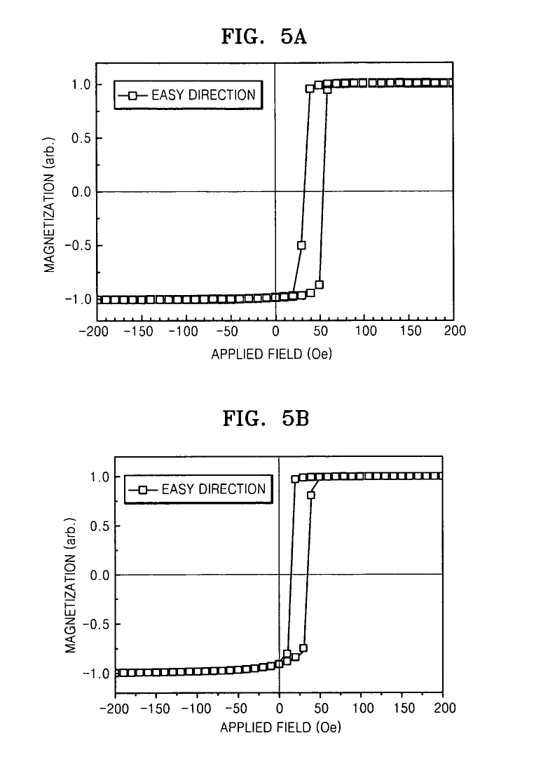

FIGS. 4A and 4B are graphs respectively illustrating an M-H characteristic, i.e., a magnetoresistance (MR) ratio of a change of magnetoresistance to a minimum magnetoresistance and an exchange coupling force (Hₑₓ), when a magnetoresistance device without a diffusion barrier layer is in an as-depo state, and an M-H characteristic when the magnetoresistance device without a diffusion barrier layer is formed and then heated at a temperature of 600° C. for 32.5 seconds. Here, the sample used for measuring the M-H characteristic was a perpendicular magnetic recording medium without a diffusion barrier layer. A seed layer of Ta with an approximate thickness of 5 nanometers is formed on a glass substrate, and a buffering layer of NiFeCr with an approximate thickness of 5 nanometers is formed on the seed layer. Also, an anti-ferromagnetic layer of IrMn with a 10 nanometer thickness is formed on the buffer layer, and a 40 nanometer-thick layer of CoZrNb is formed thereabove.

Referring to FIGS. 4A and 4B, in the case of a magnetoresistance device without a diffusion barrier layer, an exchange coupling force (Hₑₓ) is equal to 35 Oe in an as-depo state without heat treating, and the exchange coupling force (Hₑₓ) is reduced drastically to 0 Oe after heat treating in a 600° C. environment. This is because materials such as Mn of the anti-ferromagnetic layer and the Co of the buffering layer below it diffuse to other layers, adversely affecting the overall characteristics of the magnetoresistance device. Accordingly, the magnetoresistance device without a diffusion barrier layer is very unstable thermally.

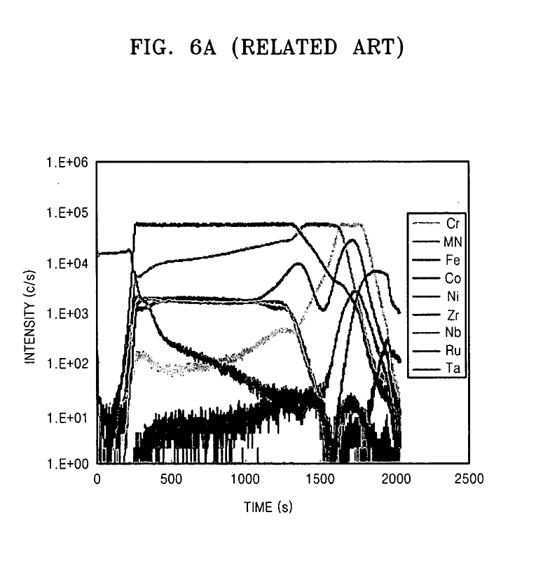

FIGS. 5A and 5B are graphs respectively illustrating an M-H characteristic when a magnetoresistance device according to an exemplary embodiment of the present invention is in an as-depo stage, and an M-H characteristic when a magnetoresistance device according to an exemplary embodiment of the present invention is heated at a temperature of 600° C. for 32.5 seconds. Here, the sample used for measuring the M-H characteristic was a perpendicular magnetic recording medium including a diffusion barrier layer. A seed layer of Ta with an approximate thickness of 5 nanometers is formed on a glass substrate, and a buffering layer of NiFeCr with an approximate thickness of 5 nanometers is formed on the seed layer. Also, a diffusion barrier layer of Ru with a 10 nanometer thickness is formed on the buffer layer, an anti-ferromagnetic layer of IrMn with a 10 nanometer thickness and a 40 nanometer-thick layer of CoZrNb are successively formed thereabove.

Referring to FIGS. 5A and 5B, in the case of a magnetoresistance device with a diffusion barrier layer, although an exchange coupling force (Hₑₓ) was equal to 35 Oe in an as-depo state without heat treating, the exchange coupling force (Hₑₓ) is 24 Oe after heat treating in a 600° C. environment. Although the exchange coupling force was reduced, when compared to the case where there is no diffusion barrier layer, the exchange coupling force still has a significant value.

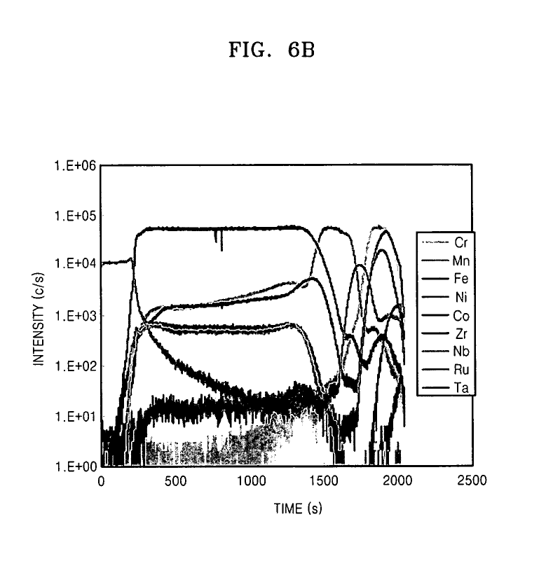

FIG. 6A is a graph illustrating results of component distribution as measured by Secondary Ion Mass Spectroscopy (SIMS) after a related art perpendicular magnetic recording medium without a diffusion barrier layer is formed and then heat-treated at a temperature of 600° C. Specifically, the composition distribution of the sample shown in FIGS. 4A and 4B was measured.

Referring to FIG. 6A, each element was widely diffused through heat treating. Especially in the case of Mn, which shows the highest peak on the horizontal axis 1500s, a high composition distribution was maintained on other layers through diffusion.

FIG. 6B is a graph illustrating results of component distribution as measured by SIMS after a perpendicular magnetic recording medium including a diffusion barrier layer according to an exemplary embodiment of the present invention is formed and then heat-treated at a temperature of 600° C. Specifically, the composition distribution of the sample in FIGS. 5A and 5B was measured.

Referring to FIG. 6B, when compared to the results of FIG. 6A, the diffusion of each element reduced substantially. Especially in the case of Mn and Cr, the diffusion was reduced to almost 1/10 of the original value when a diffusion barrier layer was present and heat treatment was performed. The use of the diffusion barrier layer prevented the diffusion of the metals forming the magnetic layer, so that thermal stability was maintained.

By providing a diffusion barrier layer between the underlayer and the anti-ferromagnetic layer in the magnetoresistance device of the exemplary embodiment of the present invention as described above, when the magnetoresistance device is formed, diffusion of important elements during heat treating and use of the device (when heat is generated) can be prevented so that the magnetic characteristics of the device can be reliably maintained.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A magnetoresistance device comprising:
a substrate;
an underlayer formed on a top of the substrate; and
a magnetoresistance structure formed on a top of the underlayer,
wherein the magnetoresistance device comprises a diffusion barrier layer formed between the underlayer and the magnetoresistance structure.

2. The magnetoresistance device of claim 1, wherein the diffusion barrier layer is formed of Ru.

3. The magnetoresistance device of claim 2, wherein the magnetoresistance structure comprises:
an anti-ferromagnetic layer;
a first ferromagnetic layer formed on a top of the anti-ferromagnetic layer, and having a magnetization direction pinned by the anti-ferromagnetic layer;
a non-magnetic spacer layer formed on a top of the first ferromagnetic layer; and
a second ferromagnetic layer formed on a top of the spacer layer, and having a changeable magnetization direction.

4. The magnetoresistance device of claim 2, wherein the magnetoresistance structure comprises:
an anti-ferromagnetic layer;
a first ferromagnetic layer formed on a top of the anti-ferromagnetic layer, and having a magnetization direction pinned by the anti-ferromagnetic layer;
a tunneling barrier layer formed on a top of the first ferromagnetic layer; and
a second ferromagnetic layer formed on a top of the tunneling barrier layer, and having a changeable magnetization direction through an application of a magnetic field.

5. The magnetoresistance device of claim 2, wherein the underlayer comprises one of a seed layer and a multi-layer comprising a seed layer and a buffer layer.

6. The magnetoresistance device of claim 1, wherein the magnetoresistance device is one of a magnetic recording head and a memory device.

7. The magnetoresistance device of claim 6, wherein the magnetoresistance structure is one of a sensor and a memory where the magnetoresistance device is one of a magnetic recording head and a memory device, respectively.

8. The magnetoresistance device of claim 1, wherein the diffusion barrier layer is adapted to prevent diffusion of a transition metal forming one of the underlayer and the magnetoresistance structure.

9. The magnetoresistance device of claim 8, wherein the transition material is at least one of Mn, Fe, Co and Ni.

10. The magnetoresistance device of claim 1, wherein the magnetoresistance structure comprises:
an anti-ferromagnetic layer;
a first ferromagnetic layer formed on a top of the anti-ferromagnetic layer, and having a magnetization direction pinned by the anti-ferromagnetic layer;
a non-magnetic spacer layer formed on a top of the first ferromagnetic layer; and
a second ferromagnetic layer formed on a top of the spacer layer, and having a changeable magnetization direction.

11. The magnetoresistance device of claim 10, wherein the anti-ferromagnetic layer is formed of an alloy comprising Mn.

12. The magnetoresistance device of claim 1, wherein the magnetoresistance structure comprises:
an anti-ferromagnetic layer;
a first ferromagnetic layer formed on a top of the anti-ferromagnetic layer, and having a magnetization direction pinned by the anti-ferromagnetic layer;
a tunneling barrier layer formed on a top of the first ferromagnetic layer; and
a second ferromagnetic layer formed on a top of the tunneling barrier layer, and having a changeable magnetization direction through an application of a magnetic field.

13. The magnetoresistance device of claim 12, wherein the anti-ferromagnetic layer is formed of an alloy comprising Mn.

14. The magnetoresistance device of claim 1, wherein the underlayer is one of a seed layer and a multi-layer that comprises the seed layer and a buffer layer.

15. The magnetoresistance device of claim 14, wherein the seed layer is formed of one of Ta and an alloy comprising Ta.

16. The magnetoresistance device of claim 14, wherein the buffer layer is formed of one of a Ta/Ru compound and NiFeCr.
